(19) United States
(12) Patent Application Publication
(10) Pub. No.: US 2004/0101042 A1
(43) Pub. Date: May 27, 2004

(54) Method for shot change detection for a video clip

(76) Inventor: Yi-Kai Chen, Tainan (TW)

Correspondence Address: BIRCH STEWART KOLASCH & BIRCH, PO BOX 747, FALLS CHURCH, VA, 22040-0747, US

(21) Appl. No.: 10/303,026

(22) Filed: Nov. 25, 2002

(51) Int. Cl. H04N 7/12

(52) U.S. Cl. 375/240.01; 348/699

(57) ABSTRACT

A method for shot change detection of a video clip. The method comprises the steps of receiving two P frames (or an I and P frame) and B frames therebetween, inversely quantizing their macroblocks to obtain energy values corresponding to the forward and backward references of the macroblocks, for each of the frames, respectively calculating the numbers of the macroblocks having the energy values corresponding to the forward and backward references below a threshold, and a forward and backward reference ratio of the two numbers to the total number of the macroblocks, and locating a shot change among the frames using the ratios.

### BACKGROUND OF THE INVENTION

1. Field of the Invention

The present invention relates to a method for shot change detection and particularly to a shot change detection for a compressed video clip.

2. Description of the Prior Art

The medium of digital video communication is widely used in many applications. Due to the rich information content of video data, queries can be specified not only by video titles, video descriptions, and alpha-numeric attributes of video data, but also by the video contents. Therefore, video index construction supporting powerful query capabilities is an important research issue for video database systems.

Video shot segmentation is a fundamental step toward video index construction. Video sequences may be segmented according to so-called “shot changes”, which are often used for video browsing. A “shot” is made up of a sequence of video frames which represents a continuous action in time and space. Therefore, the contents of the frames belonging to the same shot are similar. A shot change is defined as a discontinuity between two shots. The similarity (or dissimilarity) measurement of continuous frames may therefore be used for shot change detection.

For shot change detection, there are two major categories, uncompressed-domain and compressed-domain detection. The pixel difference, statistical difference, edge difference and histogram comparison are such approaches in uncompressed-domain. The pixel difference approach is sensitive to noise and object or camera motion. The statistical approach is slow and produces numerous erroneous results. The edge difference approach is also sensitive to noise and motion, and they are even more inefficient than pixel statistical approaches. The histogram difference approach works better in noisy and motion-rich video but still functions inefficiently. The DC image difference, motion vector, and temporal reference analyses are approaches in compressed domain. The DC image is just like a sub-sample of original frame and it works just like statistical approach but contains errors produced in compression. The errors of compression usually cause error detection. The motion vector analysis approach also depends too much on compression. The encoder determines the motion vector based on the minimum error between current block and reference block and is sometimes quite different from human perceptual. This is due to the fast algorithm of motion estimation used in codec to save more encoding time than full search algorithm. The fast algorithm of motion estimation may get the motion vector with local minimum in macroblocks (MB) matching and affect the accuracy of motion vectors. The temporal reference approach using MB type (intra, forward, backward, or bi-directional) in detecting the shot change is unstable because of the uncertainty in MB type generated by video codec.

Today, a growing amount of video is stored in compressed domains such as MPEG-1 or MPEG-2. Because the uncompressed-domain algorithm is inefficient and sensitive to noise or motion, a stable algorithm is needed to detect shot change in compressed domain. The conventional algorithms depend too much on the motion estimation of video encoder.

### SUMMARY OF THE INVENTION

The object of the present invention is to provide a method for shot change detection for a compressed video clip, which uses the energy of inverse quantization information to filter the MB type first and analyzes the temporal reference in the frames to detect shot change more accurately and efficiently.

The present invention provides a method for shot change detection of a video clip, the method comprising the steps of receiving a first frame, second frames and a third frame of the video clip, wherein each of the frames is divided into macroblocks, the third frame has the macroblocks with forward reference to the first frame and the second frames have the macroblocks with forward and backward references respectively to the first and third frame, inversely quantizing the macroblocks to obtain energy values corresponding to the forward and backward references of the macroblocks, for each of the frames, calculating a first and second number of the macroblocks having the energy values corresponding to the forward and backward references smaller than a first threshold, and a forward and backward reference ratio of the first and second number to the total number of the macroblocks, respectively, and locating a shot change among the frames, wherein the forward reference ratio of the third frame is below a second threshold, and either:

(a) the shot change is adjacent to the first frame and the backward reference ratio is larger than the forward reference ratio of each of the second frames subsequent to the shot change,

(b) the shot change is located between two of the second frames, the forward reference ratio is larger than the backward reference ratios of each of the second frames preceding the shot change and the backward reference ratio is larger than the forward reference ratio of each of the second frames subsequent to the shot change, or

(c) the shot change is adjacent to the third frame and the forward reference ratio is larger than the backward reference ratio of each of the second frames preceding the shot change.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 illustrates a typical structure of MPEG coded frames.

FIG. 2 is a flowchart of the method for shot change detection of an MPEG-coded video clip according to one embodiment of the invention.

FIG. 3A-3B are diagrams showing the shot change detected by the method according to one embodiment of the invention.

### DETAILED DESCRIPTION OF THE INVENTION

In the MPEG coding structure, a frame is divided into macroblocks. Each macroblock is a 16×16 image in the form of a basic coding unit. A macroblock can be intra coded, or inter coded by references its adjacent frames when it matches the similar image patterns of these adjacent frames. A macroblock coded without reference is called an intracoded macroblock. A macroblock which references similar image patterns is called forward-prediction coded, backward-prediction coded, or bi-directional-prediction coded, while it references the image patterns of the preceding frame, subsequent frame, or both preceding and subsequent frames, respectively. A reference the preceding frame is named forward reference, and to the subsequent frame, backward reference.

In accordance with the MPEG referencing patterns of macroblocks, there are three types of frames; namely, I frame, P frame and B frame. All macroblocks in an I frame must be intra-coded. That is, the I frame is independently coded, and can be decompressed without referencing other frames. Macroblocks of the P frame may have forward references its preceding I or P frame. That is, a P macroblock is a forward-prediction coded macroblock when a similar image pattern is found in the preceding I or P frame. Otherwise, it is intra-coded when a similar image pattern can not be found in the preceding I or P frame. A B frame may have references its adjacent I or P frames. The macroblock in a B frame can be a bi-directional-prediction coded, forward-prediction coded, backward-prediction coded, or intra coded macroblock.

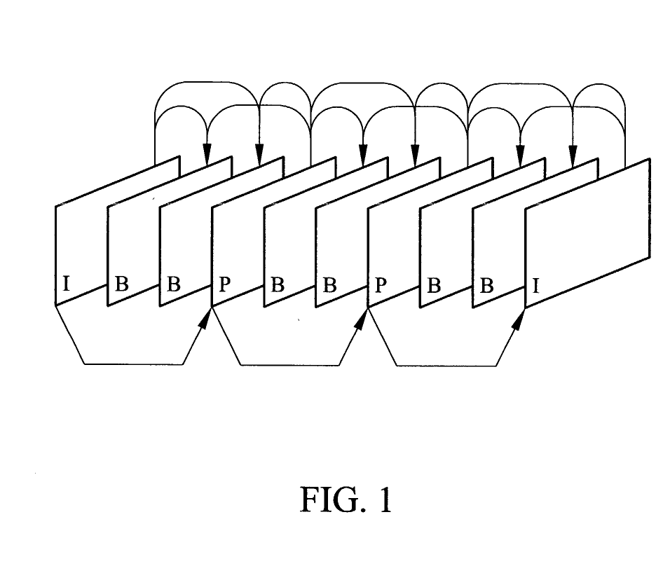

In MPEG-coded video, the number and sequence of I, P, and B frames are predetermined. In general, a number of P and B frames are situated between two I frames, and a number of B frames may be between two P frames, or between an I and a P frame. FIG. 1 illustrates a typical structure of MPEG coded frames. In FIG. 1, the ratio of the numbers of I, P, and B frames (called the IPB-ratio) is 1:2:6. That is, an I frame is followed by one P frame and four B frames in the sequence shown.

For the P and B frames, macroblocks may reference adjacent frames. The number of macroblocks for each type of reference may be computed as a reference ratio to measure the similarity between adjacent frames. Two types of reference ratios are defined as follows:

Forward reference ratio F_{R}=N_{f}/N . . . (1) where N_{f} is the number of forward-prediction coded macroblocks in a frame, and N is the total number of macroblocks in the frame.

Backward reference ratio B_{R}=N_{b}/N . . . (2) where N_{b} is the number of backward-prediction coded macroblocks in a frame, and N is the total number of macroblocks in the frame.

With F_{R} and B_{R}, the similarity between adjacent frames can be evaluated to perform shot change detection in the compressed video domain.

However, it is possible that the number of forward-prediction coded macroblocks N_{f} and/or the number of backward-prediction coded macroblocks N_{b} can be wrongly indicated because of an improper threshold setting or some fast algorithm during motion estimation of MPEG encoder. There exists a need to provide a method so that potential detection errors can be further reduced.

Based on the present invention, all macroblocks in each frame are inversely quantized to obtain energy information for the corresponding macroblock differences, such as DCT of the corresponding macroblock differences. The energy information for each macroblock is then compared with a given energy threshold to confirm the similarity with the reference macroblock. Macroblocks with their energy information higher than the given threshold are deemed potentially false and are excluded from the number of forward-prediction coded macroblocks N_{f} or the number of backward-prediction coded macroblocks N_{b}. Therefore, the modified number of forward-prediction coded macroblocks N_{f}′ and the modified number of backward-prediction coded macroblocks N_{b}′ can be made more accurate. Next, the shot change detection can be implemented with the modified N_{f}′ and N_{b}′, with potential miscount in N_{f} and N_{b} eliminated, no matter what and how the threshold setting is given in the earlier motion estimation.

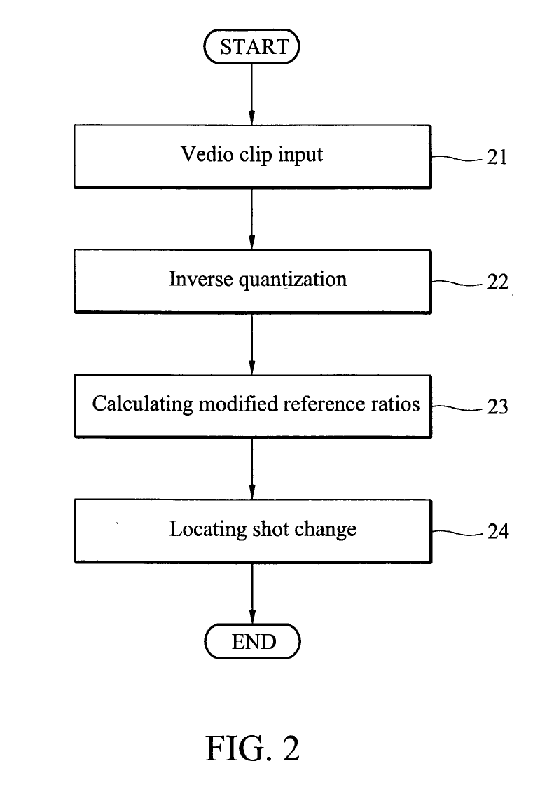

FIG. 2 is a flowchart of the method for shot change detection of an MPEG-coded video clip according to one embodiment of the invention.

In step 21, an I or P frame, another P frame and B frames therebetween of the video clip are received.

In step 22, the macroblocks in the received frames are inversely quantized to obtain energy values corresponding to the forward and backward references of the macroblocks.

In step 23, for each of the received frames, calculating the numbers N_{f}′ and N_{b}′ of the macroblocks having the energy values corresponding to the forward and backward references below a threshold, and the forward and backward reference ratios F_{R}′ and B_{R}′ of the numbers N_{f}′ and N_{b}′ to the total number of the macroblocks, respectively.

In step 24, a shot change is located among the frames, wherein the forward reference ratio F_{R}′ of the P frame in the end is below a threshold, and either:

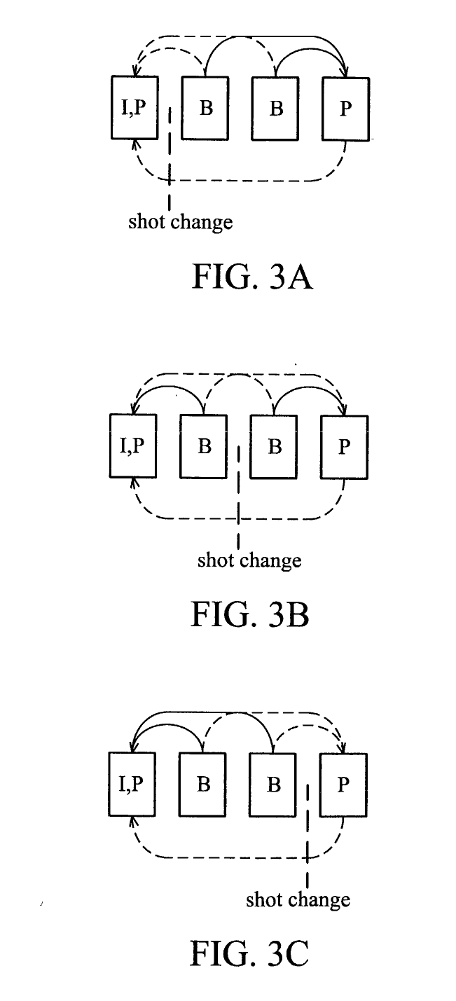

(a) the shot change is adjacent to the first I or P frame and the backward reference ratio B_{R}′ is much larger than the forward reference ratio F_{R}′ of each of the B frames subsequent to the shot change (as shown in FIG. 3A wherein the solid line means a larger reference ratio in its direction and the dotted line means the a smaller reference ratio in its direction),

(b) the shot change is located between two of the B frames, the forward reference ratio F_{R}′ is much larger than the backward reference ratio B_{R}′ of each of the B frames preceding the shot change and the backward reference ratio B_{R}′ is larger than the forward reference ratio F_{R}′ of each of the B frames subsequent to the shot change (as shown in FIG. 3B), or,

(c) the shot change is adjacent to the P frame and the forward reference ratio F_{R}′ is larger than the backward reference ratio B_{R}′ of each of the B frames preceding the shot change (as shown in FIG. 3C).

Thus, the accuracy of the prior art shot change detection can be effectively improved without much cost.

In conclusion, the method in the present invention can be used to detect the shot change of video clips in compressed domains such as MPEG-1, 2, 4, H263, and H263+ video. The detection method can separate the shot cut for further analysis, video classification or removing commercials. The method uses the energy of inverse quantization information to filter the MB type first and analyzes the temporal reference in the frames to detect shot change more accurately and efficiently.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method for shot change detection of a video clip, the method comprising the steps of:
receiving a first frame, second frames and a third frame of the video clip, wherein each of the frames is divided into macroblocks, the third frame has the macroblocks with forward reference to the first frame and the second frames have the macroblocks with forward and backward references respectively to the first and second frames;
inversely quantizing the macroblocks to obtain energy values corresponding to the forward and backward references of the macroblocks;
for each of the frames, calculating a first and second number of the macroblocks having the energy values corresponding to the forward and backward references smaller than a first threshold, and a forward and backward reference ratio of the first and second number to the total number of the macroblocks, respectively; and
locating a shot change among the frames, wherein the forward reference ratio of the third frame is below a second threshold, the shot change is adjacent to the first frame and the backward reference ratio is larger than the forward reference ratio of each of the second frames subsequent to the shot change.

2. The method as claimed in claim 1, wherein the first, second and third frames are an I frame, B frames and P frame.

3. The method as claimed in claim 1, wherein the first, second and third frames are a P frame, B frames and another P frame.

4. The method as claimed in claim 1, wherein the video clip is an MPEG-coded video clip.

5. The method as claimed in claim 4, wherein the ratio of the numbers of I, P and B frames is 1:2:6.

6. A method for shot change detection of a video clip, the method comprising the steps of:
receiving a first frame, second frames and a third frame of the video clip, wherein each of the frames is divided into macroblocks, the third frame has macroblocks with forward reference to the first frame and the second frames have macroblocks with forward and backward references respectively to the first and second frame;
inversely quantizing the macroblocks to obtain energy values corresponding to the forward and backward references of the macroblocks;
for each of the frames, calculating a first and second number of the macroblocks having the energy values corresponding to the forward and backward references smaller than a first threshold, and a forward and backward reference ratio of the first and second number to the total number of the macroblocks, respectively; and
locating a shot change among the frames, wherein the forward reference ratio of the third frame is below a second threshold, the shot change is located between two of the second frames, the forward reference ratios are larger than the backward reference ratios of each of the second frames preceding the shot change and the backward reference ratios are larger than the forward reference ratios of each of the second frames subsequent to the shot change.

7. The method as claimed in claim 6, wherein the first, second and third frames are an I frame, B frames and P frame.

8. The method as claimed in claim 6, wherein the first, second and third frames are a P frame, B frames and another P frame.

9. The method as claimed in claim 6, wherein the video clip is an MPEG-coded video clip.

10. The method as claimed in claim 9, wherein the ratio of the numbers of I, P and B frames is 1:2:6.

11. A method for shot change detection of a video clip, the method comprising the steps of:
receiving a first frame, second frames and a third frame of the video clip, wherein each of the frames is divided into macroblocks, the third frame has macroblocks with forward reference to the first frame and the second frames have macroblocks with forward and backward references respectively to the first and second frame;
inversely quantizing the macroblocks to obtain energy values corresponding to the forward and backward references of the macroblocks;
for each of the frames, calculating a first and second number of the macroblocks having the energy values corresponding to the forward and backward references smaller than a first threshold, and a forward and backward reference ratio of the first and second number to the total number of the macroblocks, respectively; and
locating a shot change among the frames, wherein the forward reference ratio of the third frame is below a second threshold, the shot change is adjacent to the third frame and the forward reference ratio is larger than the backward reference ratio of each of the second frames preceding the shot change.

12. The method as claimed in claim 11, wherein the first, second and third frames are an I frame, B frames and P frame.

13. The method as claimed in claim 11, wherein the first, second and third frames are a P frame,: B frames and another P frame.

14. The method as claimed in claim 11, wherein the video clip is an MPEG-coded video clip.

15. The method as claimed in claim 14, wherein the ratio of the numbers of I, P and B frames is 1:2:6.
